(19) United States
(12) Patent Application Publication
(10) Pub. No.: US 2008/0195543 A1
(43) Pub. Date: Aug. 14, 2008

(54) Digital Evidence Bag

(75) Inventor: Philip Bryan Turner, Worcestershire (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: QINETIQ LIMITED

(21) Appl. No.: 11/915,602

(22) PCT Filed: May 26, 2006
(86) PCT No.: PCT/GB2006/001942

§ 371 Date: Nov. 27, 2007

(30) Foreign Application Priority Data
May 27, 2005 (GB) 0510878.2
Apr. 13, 2006 (GB) 0607489.2

(51) Int. Cl. G06Q 10/00; G06F 17/30; H04L 9/28

(52) U.S. Cl. 705/50; 705/1

(57) ABSTRACT

Data structures, methods, programs for computers, apparatus and systems for capturing, and analysing digital data, especially in the context of digital evidence gathering and analysis. Digital evidence is captured in digital evidence bags having an index file and one or more evidence units, the evidence units each comprising an index file and an evidence file. The evidence files contain copies of raw captured data whilst the associated index files contain text details of the contents and structure of the evidence files. The tag file contains data descriptive of the source and/or provenance of the evidence units and/or the digital evidence bag as a whole. Index information and evidence data may be in the same or distinct files.

### FIELD OF THE INVENTION

The present invention relates to apparatus, methods, data structures, and programs for computers for digital evidence gathering, tracking, and analysis and systems incorporating the same.

### BACKGROUND TO THE INVENTION

In the world of law enforcement when a crime scene is visited in the course of an enquiry or investigation, the law enforcement officers use bags and seals to store items of evidence that are found which are considered relevant at the time. The item would then be placed into a bag which is sealed at the scene. The seal number is recorded and a tag is attached which may include details such as:
Investigating Agency/Police Force;
Exhibit reference number;
Property reference number;
Case/Suspect name;
Brief description of the item;
Date and time the item was seized/produced;
Location of where the item was seized/produced;
Name of the person that is producing the item as evidence;
Signature of the person that is producing the item;
Incident/Crime reference number;
Laboratory reference number.

The tag also contains sections for continuity purposes that can be signed when other people take custody of the item. This is used to provide continuity and assure provenance of the item from the time the item was seized to the time the item is used as evidence in court, restored to the owner, or destroyed.

The continuity sections usually show the following details:
name/Rank and number of person taking custody of the item;
signature of the person taking custody of the item;
date and time the person takes custody of the item.

It is not uncommon for many bags of evidence to be seized when a crime scene is visited and the size, shape and type of those bags vary depending upon the contents and type of article. For this reason different capacity bags are used.

This individual wrapping also permits various articles to be distributed between the various specialist laboratories that can process that item. For example some items may require fingerprint analysis, others may require DNA analysis, whilst others may just require interpretation of their contents by the investigating officer.

As computer technology has become ever more sophisticated and storage media capacities have increased, forensic capture and analysis digital evidence for investigation has become ever harder.

Currently in the digital world the closest equivalent to the physical evidence capture process is either the plain ‘dd’ image file (see, for example, “The Linux Kernel and the Forensic Acquisition of Hard Disks with an Odd Number of Sectors”—Jesse D. Kornblum, International Journal of Digital Evidence, Fall 2004, Volume 3, Issue 2) or one of many proprietary formats produced by various forensic tool vendors.

Traditional methods of forensic data capture involve copying a complete digital image of a digital medium (e.g. computer hard disc) as a single digital image, which must subsequently be analysed as a single entity by analysis tools.

The ‘dd’ raw file capture contains no method of attaching details such as the date and time of capture, the person performing the capture process, or any mechanism to help assure the integrity of what has been captured. These features can be generated after the capture but usually require additional actions of the person carrying out the process as separate distinct functions.

Given that currently available electronic storage discs may have capacities of at least 250 Gb—a figure which is almost certain to increase in the future—the task of processing such large units of data is becoming unmanageable.

Nevertheless, there is a legal need to ensure that base data used in analysis comprehensively and accurately reflects the contents of the system under investigation precisely at the time the digital evidence was captured. Capture of a complete digital image of the systems under investigation has therefore been deemed necessary to satisfy that requirement.

These methods generally capture the whole of the evidence into a single one size fits all data ‘entity’. If the item being captured is too large to fit into one file, as it often is given the ever-increasing capacity of modern hard disk drives, then the file is fragmented into ‘chunks’. This is to allow the file to be backed up later, or to be split between multiple smaller media if insufficient capacity single storage devices are not available at the time of capture. However, in order to be able to process the contents of either of these types of data capture output, the totality of the fragmented files usually has to be made available again to the single application that is going to be used to process that evidence.

As a result, known digital evidence analysis tools are designed to operate only on these large digital dump files despite, for example, an investigator's knowledge that, for a financial irregularities investigation, analysis of only certain kinds of file (e.g. spreadsheets and letter and memo formats) may be most appropriate and efficient whilst for a musical copyright infringement investigation analysis of music download file formats and web log files may be most appropriate. Nevertheless present evidence capture provides only a one-size-fits-all solution in the form of capture of a digital dump of the system being investigated and subsequent analysis of that complete dump as a single entity.

There is a further need to be able to provide evidence of the provenance of any digital evidence submitted as courtroom evidence: that is, evidence that the digital image submitted is indeed a faithful and complete copy of the system under analysis and that it has not been tampered with (see for example “Digital Provenance—Interpretation, Verification & Corroboration”—Philip Turner, Digital Investigation, 2005).

Referring to FIG. 1, the system described in the EnCase® Legal Journal system (published by Guidance Software, December 2004—sections 5.0-5.5) provides a system in which digital evidence 1 can be downloaded into an evidence file 10. The data may optionally be compressed for space efficiency, provided that the compression algorithm preserves all the detail of the original data. CRC digits are appended to individual sectors throughout the binary dump, and stored as separate blocks 11 scattered throughout the file. These check digits provide the means of confirming that individual blocks have been neither tampered with nor accidentally corrupted. By associating them with sub-blocks of the entire binary dump it also mitigates the evidential impact of such corruption, from whichever cause, thereby allowing other uncorrupted blocks from the same file potentially to continue to be admitted as evidence. An MD5 hash 121 of the whole binary image is also stored in a footer component 12 of the evidence file so as to provide further data integrity checks to protect against corruption or tampering.

To provide provenance (or “chain of custody”) information, each EnCase Evidence file also comprises a header section 13 containing custody information: for example the identity of the examined computer, date and time of evidence image capture, identity of investigator making the image, etc, along with an MD5 hash value for the captured data at the time of acquisition. This provenance information cannot however be modified from within the EnCase software, and therefore cannot be used to track subsequent changes of custody or analyses performed upon the evidence file. The provenance information is designed solely to represent provenance at the moment of data capture.

Furthermore, since the Encase system embeds data other than that from the original source (e.g. header 13, footer 12, and CRC check digits 11) within the evidence files 10, it is in general impractical to apply other COTS analysis tools to those evidential files since they are not designed to take account of such proprietary file structurings. Instead it is recommended that investigators first restore a physical device from the EnCase image and then apply the other analysis tools to that image. This process is potentially highly time consuming and also, by extracting the image data from within the Evidence file, potentially breaks the provenance chain from the original.

The paper “Breaking the Performance Wall: The Case for Distributed Digital Forensics” (Vassil Roussev, Golden G. Richard III, Department of Computer Science, University of New Orleans, La. 70148) discusses distribution of analyses of digital evidence. Patent application U.S. 2004/0260733 A1 discloses techniques for allowing a user to remotely interrogate a target computing device in order to collect and analyze computer evidence which may be stored on the target computing device.

Patent application EP 0 893 763 A1 discloses systems for verifying and authenticating the integrity of data copied from computer memories. It employs hash values calculated over individual blocks of copied data, the hash values being encrypted and stored on external media (e.g. floppy disk).

### SUMMARY OF THE INVENTION

According to a first aspect of the present invention, there is provided a method of capturing digital data, the method comprising the steps of: copying digital data from a data source into one or more evidence files; for each evidence file recording data descriptive of at least one of the source and the contents of the digital data in the evidence file; recording, in a tag file, data indicative of provenance of the digital data in the one or more evidence files.

The digital data may be copied into a plurality of evidence files.

The digital data may be selectively copied from the source (i.e. not all the data from the given source need be copied into any given evidence file.)

For each evidence file, the data descriptive of one of the source and contents of the digital data may be stored in an index file distinct from the evidence file.

A distinct index file may be created for each evidence file.

The data descriptive of one of the source and contents of the digital data may comprise a digital fingerprint of the digital data.

The tag file may comprise a digital fingerprint of at least one of the evidence files.

The tag file may comprise a description of the format of the data descriptive of one of the source and contents of the digital data.

The data source may be a data storage medium (or other static data medium)

The data source may be a data transmission medium (or other dynamic data medium).

In some embodiments multiple indications of provenance are associated with at least one given item of the digital data in the one or more evidence files.

According to a second aspect of the present invention there is provided a program for a computer having respective code portions and data structures to perform the steps of the methods of other aspects of the invention.

According to a third aspect of the present invention there is provided apparatus for capturing digital data, the apparatus comprising: means for copying digital data from a data source into one or more evidence files; for each evidence file, means for recording data descriptive of at least one of the source and the contents of the digital data in the evidence file; means arranged to record, in a tag file, data indicative of provenance of the digital data in the one or more evidence files.

According to a fourth aspect of the present invention there is provided a data structure for capturing digital data, the data structure comprising: at least one evidence file for containing digital data copied from a data source; at least one index file containing data descriptive of at least one of the source and contents of the digital data in the at least one evidence files; a tag file containing data indicative of provenance of the digital data in the at least one evidence files.

According to a fifth aspect of the present invention there is provided a method of accessing a data structure according to the fourth aspect, the method comprising the steps of: identifying one or more evidence files to be accessed; recording details of the evidence file access in the tag file of the data structure; recording a new integrity check value in the tag file, responsive to the contents of the tag file including the newly-recorded details of the evidence file access.

The details of the evidence file access may comprise at least one of: identification of the application performing the evidence file access; identification of the user requesting evidence file access; identification of the time of evidence file access;

The integrity check may be a digital fingerprint, for example one of a CRC digits, an MD5 hash, and a SHA hash.

According to a sixth aspect of the present invention there is provided apparatus for accessing a data structure according to the fourth aspect, the apparatus comprising: means for identifying one or more evidence files to be accessed; means for recording details of the evidence file access in the tag file of the data structure; means for recording a new integrity check value in the tag file, responsive to the contents of the tag file including the newly-recorded details of the evidence file access.

According to a seventh aspect of the present invention there is provided a method of updating a data structure according to the fourth aspect, the method comprising the steps of: accessing the data structure to extract evidential data contained within it; processing evidential data extracted from the data structure to create a new evidence file and corresponding index file; adding the new evidence file and index file to the existing data structure; appending continuity information to the tag file of the data structure indicative of the addition of the new evidence file and index file.

According to a eight aspect of the present invention there is provided apparatus for updating a data structure according to the fourth aspect, the apparatus comprising: means for accessing the data structure to extract evidential data contained within it; means for processing evidential data extracted from the data structure to create a new evidence file and corresponding index file; means for adding the new evidence file and index file to the existing data structure; means for appending continuity information to the tag file of the data structure indicative of the addition of the new evidence file and index file.

Advantageously, use of a common format for capturing digital data/evidence of disparate types and sizes facilitates tracking of provenance of such digital evidence whilst also facilitating efficient and selective analysis of the data by disparate analysis methods and tools. Such analysis may also be conducted concurrently on copies of the evidential data whose provenance from the original data can be tracked and verified.

The invention also provides for systems for the purposes of digital data/evidence capture and analysis which comprise one or more instances of apparatus embodying the present invention, together with other additional apparatus.

The invention also provides for computer software in a machine-readable form and arranged, in operation, to carry out every function of the apparatus and/or methods.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 shows a schematic diagram of a prior art digital evidence data structure;

FIG. 2 shows a schematic diagram of a digital evidence data structure in accordance with the present invention;

FIG. 3 shows a schematic diagram of a tag file update method according to the present invention; and

FIG. 4 shows an example of a tag file in accordance with the present invention.

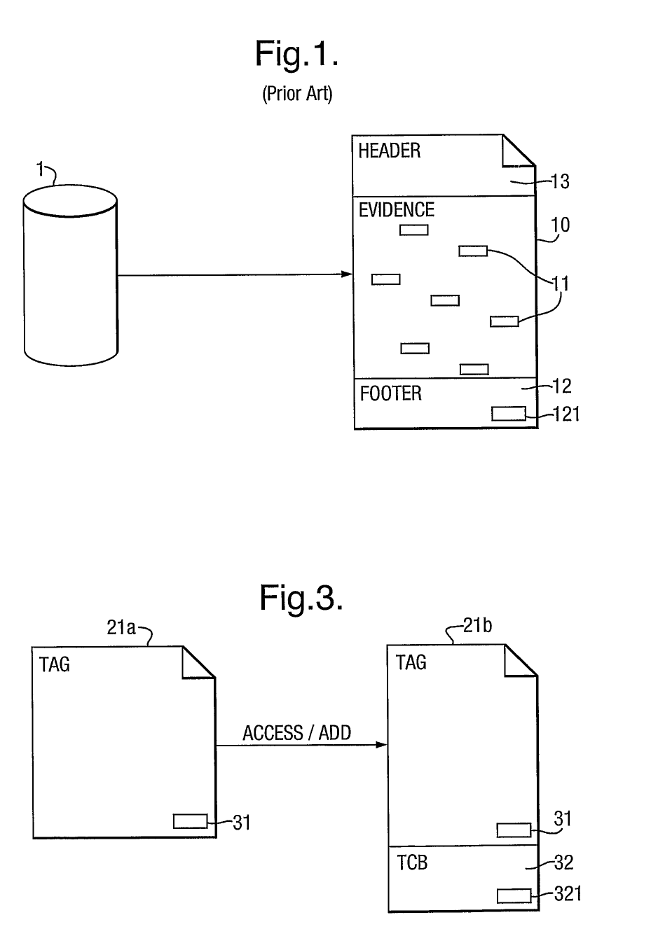

### DETAILED DESCRIPTION OF INVENTION

Referring now to FIG. 2 a Digital Evidence Bag (DEB) 20 is a structured wrapper for any type of digitally based evidence or information. A DEB may have arbitrarily large capacity, subject of course to the physical limits of the storage media available to carry it. Depending upon the user requirements a DEB may store information that could be captured either in a static environment (for example an image of a magnetic or optical storage medium) or in a real-time environment (for example a record of digital traffic over a communications medium).

A DEB comprises a tag file 21 and one or more evidence units (EU) 22a, 22b. Each evidence unit in turn comprises index information 221 and a unit of digital evidence 222. Whilst the index information and the digital evidence itself are preferably contained in separate files (an index file and an evidence file) as illustrated, the index information could alternatively be stored in the same file as the digital evidence, for example as a recognisable file header.

Furthermore, each evidence file contains its own tag information complete with integrity assurance information.

Such DEB's allow digital information of almost any size and from any source to be stored in a forensically sound manner. Furthermore the model allows evidence stored in DEB's to be distributed to different applications which may also perform different tasks upon the contents of those evidence files. This approach also allows application independence, and permits applications which perform the same task—albeit in a different manner (e.g alternate keyword search algorithms)—to work on the same evidence, potentially concurrently.

The tag file 21 is preferably a plain text file, though it is possible that other more complex file formats may be employed (for example Microsoft Word format). The tag file contains descriptive details of the evidence units contained within the DEB of which it forms part. The information contained in the tag file is analogous to that which might be found on a physical tag attached to physical evidence when it is seized, and may for example comprise one or more of the following, or similar, items:
an investigation identifier;
an evidence identifier or reference;
identification of the individual capturing the information;
a date and time when the capture process occurred;
a textual description of the contents of the DEB;
continuity information.

In the digital environment however there is more scope to record information about the evidence and maintain its integrity than there is in the physical world. The tag file may therefore also be used to record the provenance of information in the DEB and to provide a continuity record of the information contained within the DEB. The tag file in a DEB can also be used to record when a DEB analysis application accesses the DEB and also to record which analyses have been performed on any EU in the DEB.

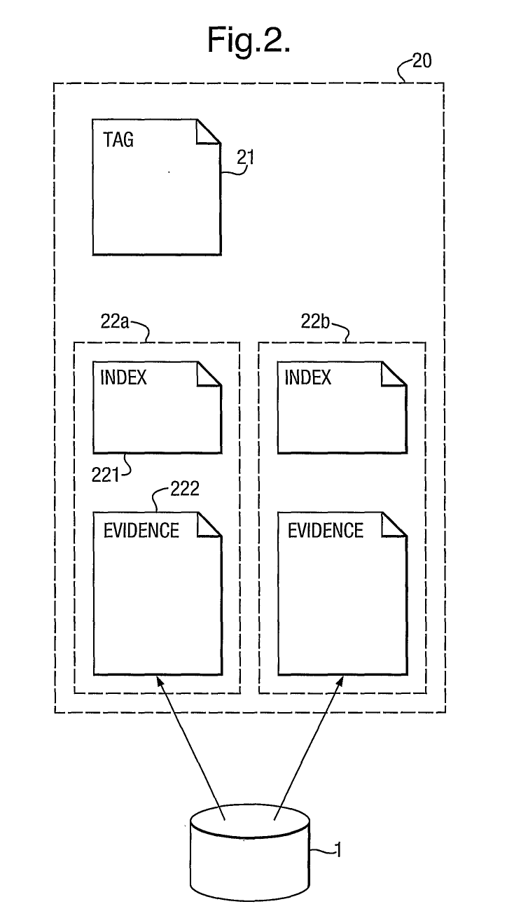

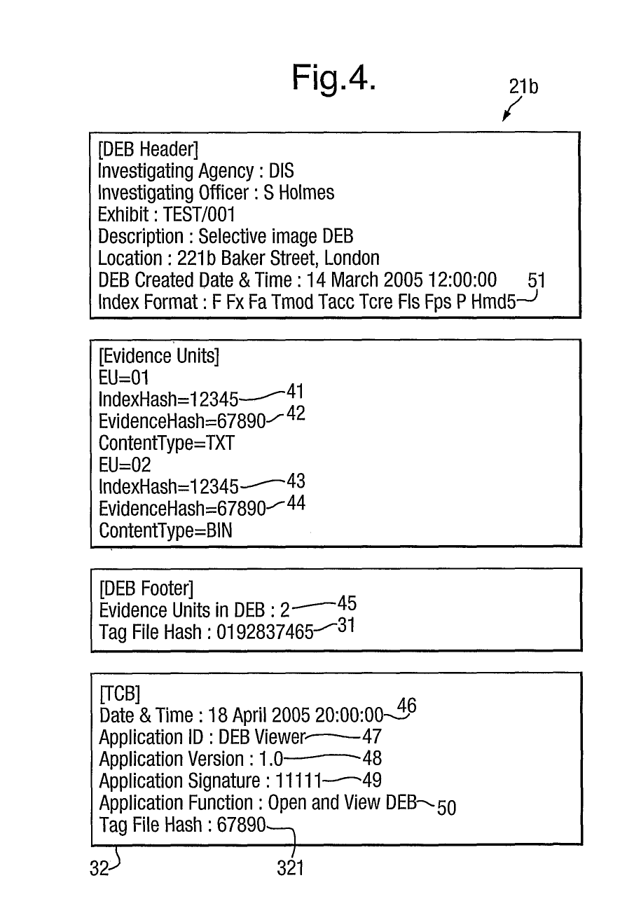

Referring now to FIGS. 3 and 4, the tag file 21a may also comprise:
a count 45 of the number of EU's in the DEB;
integrity checks 42, 44 (e.g. CRC digits or hash) of the captured evidential data in the evidence files; and
integrity checks 41, 43 (e.g. CRC digits or hash) of the or each index file; and
a tag seal integrity check (e.g. hash number) 31 comprising a hash of the tag file to date.

The tag file 21a may also comprise one or more Tag Continuity Blocks (TCB) 32. A TCB is appended (or otherwise added) to the tag file 21b each time an application performs a function on the DEB as a whole or performs a function on one or more EU's within the DEB. The TCB's may capture some or all of the following or similar DEB access data: the date and time 46, version 47, application ID 47, application signature (hash) 49, and function 50 of the application that has been applied to the DEB or EU. As each new TCB is appended to the tag file, a new tag seal hash number 321 is also appended, calculated over the updated contents of the tag file 21b including the preceding contents of the newly-appended TCB 32 and any previously recorded tag seal hash numbers 31 previously present in the tag file.

An important component which affords the DEB the flexibility to hold information captured from a variety of sources (i.e. static, real-time, or selective data) is the Meta Tag structure 51 used within the DEB header. In certain circumstances it may be advantageous to compress or encrypt the contents of either a whole DEB or part (EU). This is reflected in the index file by recording an encrypted or compressed content format type.

In order to define the contents and format of the content of the index the structure is defined in the tag file. The structure definition comprises a series of Meta Tags (MT). The MTs are used to define both sequence of fields and content type of the index. The index in turn holds information relating to the contents of the bag. Examples of Meta tag definitions include, but are not limited to:
<F>=Filename
<Fx>=Filename extension/type
<Fa>=File Attributes (E.g. System, Read, Archive, Hidden)
<Fmft>=MFT Index number
<Fls>=Logical File Size in bytes
<Fps>=Physical File Size occupied
<P>=Filepath/Provenential Information
<Ds>=Data source (PDA)—RAM, ROM, Database (User Data), SIM, Handset
<Hmd5>=Hash MD5
<Hsha>=Hash SHA
<Tmod>=Timestamp—modified
<Tacc>=Timestamp—accessed
<Tcre>=Timestamp—created
<Temo>=Timestamp Entry modified (NTFS)
<Tpacket>=Packet time
<Ddes>=Device Descriptor
<Dman>=Device Manufacturer
<Dmod>=Device model
<Dsn>=Device Serial Number
<Dcap>=Device capacity
<Dpin>=Device PIN, security access code, password
<Dsp>=Device service provider (phone)
<Raw>=Bag contents are RAW/binary no structure

Where particular index file formats become, for example, common or standard abbreviations may of course be introduced for brevity. For example an abbreviation:
<FAT12>
   may be used to denote the meta tag sequence:
<F><Fx><Fa><Fls><Fps> . . . etc.

Although only a single index format 51 applicable to all EU's within the DEB is illustrated in FIG. 4, clearly the index format details may be defined on a per-index file basis.

Each index file is a tab-delimited plain text file (though other formats may be used), containing a list detailing the contents of the corresponding evidence file. The index file may contain details such as a list of filenames, folder paths, and timestamp information relating to the contents of the digital information in the corresponding evidence file. It may contain details of a physical device from which the evidence was extracted, for example the make, model, and serial number of the device captured. The exact format and structure of the index file is reflected in the tag information in the tag file 21. The tag information therefore provides to analysis tools an indication of the structure within the various evidence units since, unlike known systems, the individual evidence units may exhibit different structure.

The evidence files contain the actual evidential data/information itself. The contents of these evidence files may be, but is not limited to, raw binary information (e.g. from a raw device capture as in known systems), files (e.g. from logical volume acquisition), structured binary information (e.g. from network protocol packet capture), or categorized files (e.g. one evidence file containing all text files, another containing all Microsoft Word documents, or another containing all JPEG graphics files, etc.).

Creating one evidence file per evidence source file acquired (e.g. one JPEG file into one evidence file) is also an option. Whilst this may lead to very large tag files, it may be appropriate where individual files may be of particular evidential interest.

DEB application programs may be provided which update the tag file so that its contents reflect the history of operations performed on the evidence files. Such information would include the date and time the application was applied to the evidence unit, include an application signature so that it is known what category of application and what version of application was used. The DEB application should also update the tag seal number.

To support the DEB model, applications which can create and use DEB's can be described in number of categories:
DEB capture applications: These are used to create the DEB from any type of digital source whether it be static disk capture, PDA capture, mobile telephone capture or live network packet capture to name but a few. The importance of this is that all these various digital processes can store evidence in a common data structure in the form of a DEB, as described above.
DEB analysis applications—These are used to perform an operation on an already created DEB. The type of operations that may be undertaken include, but are not limited to, keyword searches, hash analysis, graphical image analysis and characterisation, password cracking, log file analysis etc. When an operation is undertaken on the contents of a DEB, a log may be kept in the tag file of the function that was performed on the evidence. This provides an audit trail of the date, time, type of task, version of DEB analysis application that was used.

If information from disparate digital sources is encapsulated into DEB's and processed using the DEB analysis application then this would significantly streamline the processing of digitally based evidence. It also allows tool vendors to create applications which can operate on a self-contained DEB and allow investigators to obtain tools that perform specific operations on EU's. This would allow analysis applications to be provided by different vendors to work on the same evidence, without requiring the investigator to translate the format in which that information was acquired, into another format, just to run against another tool. This will have the effect of reducing time in conversion and the storage capacity required to hold the various versions of what is ultimately exactly the same information, but stored with different headers, or in an uncompressed format.

Because of the flexibility that DEB's bring to the world of digital forensics, the current dumb approach to image capture (i.e. start from the beginning of the media and capture everything until the end) can be replaced with imagers that operate in a more intelligent or selective manner. For example an imager could capture all files of one particular type to one DEB and another type to another DEB. Similarly the imager could be more ‘intelligent’ and target specific information for example a forensic triage could be carried out just capturing system configuration information thus allowing the investigator the opportunity to discover the operating capability that a system possessed. Alternatively if the focus of an investigation was very narrow, for example to determine if a system contained indecent images then an imager could capture specific types of files to a DEB.

It is also noted that DEB format and structure is such that it can be used with existing applications run from a ‘wrapper’ application. This permits existing applications to be used immediately with no, or minimal, modification but with the additional benefits of information assurance, integrity and continuity provided by the DEB data structure and methods.

The ability of a DEB or EU to hold entirely one type of information allows the whole digital case to be divided between systems, applications or process that can handle that category of information. Extending this further allows DEB's or EU's to be distributed across a range of systems in a multitasking and or multiprocessing environment to applications that are best suited to deal with that category of information. This would allow a forensic controller the ability to distribute DEB's or EU's to worker (client) applications safe in the knowledge that those workers would update the DEB continuity information showing what process or function was carried out on that evidence.

As a DEB or EU is passed to different analysis applications, the continuity information on the seal is updated. Thus it provides a log of the tasks and processes performed on that evidence.

Another feature of the DEB concept is the ability to maintain continuity information and to be able to show the provenance of the information contained within the DEB. Coupled with this is the requirement to both maintain and assure the integrity of the evidence within the DEB.

A practical approach to introducing and utilizing DEBs is to employ an extensible format definition which can develop over time and may therefore be enhanced to meet future requirements. Thus early implementations of the DEB approach might use it as a ‘wrapper’ for current forensic tools and applications. This has an immediate benefit that experience can be gained in using and applying DEB format with the tools that are commonly used and accepted today.

There is no manual on how to be an investigator, and passing on the knowledge of what makes a good investigative practice is very difficult and time consuming. In the digital world just keeping up with the current technological advances is almost impossible. However, the DEB approach of logging which applications and processes are carried out on the evidence, along potentially with the sequence in which those analysis tasks are performed in an automated process, enhances investigators’ ability to learn the most effective order to undertake tasks.

Furthermore, this type of mechanism could also assist in the testing and certification of investigators, as it would permit trainees to undertake test cases and record how investigators tackled them.

The following advantages are immediately evident from the data structures and methods described:
Scaleable approach to evidence acquisition;
Scalable approach to forensic processing, allowing for the first time the digital evidence to be processed across multi-processor and distributed systems;
Increased evidential material throughput, directing the most applicable techniques to the appropriate types of evidence;
Incorporate some of the current evidence capture and analysis methods thus not negating the financial investment in current tools and methods;
The ability to process evidence from a diverse range of digital devices;
Allow the integration of real-time data acquisition into a sound forensic framework;
Permit a selective and/or intelligent data acquisition approach to be implemented as opposed to the current collect everything approach;
The ability to automatically create an audit trail of processes carried out on a piece of evidence, the metric from which could allow analysis of the most effective way to process digital evidence and be used to educate new practitioners in the best way to undertake a forensic investigation.

Although described predominantly in the context of digital evidence gathering, the present inventions not limited to such applications but may also be applied in other situations in which provenance and continuity of captured data is important, as would be apparent to the person skilled in the art.

Partial or selective data copying may be considered as an alternative to capturing the whole image when it may not be practical to acquire everything. Such partial copying is know as “selective imaging”. One reason for applying a selective approach is the quantity of information that may have to be acquired. Other reasons for performing a selective acquisition may include but are not limited to forensic triage, intelligence gathering, and legal requirements. There may be legal reasons why a selective approach should be adopted, for example a case involving Legal Professional Privilege (LPP) material. Adopting a selective approach has certain risks associated with it, but this in no way means the evidence should not be gathered in any less scientific or rigorous manner.

There are several types of selective imaging techniques that may be used. These include manual selective imaging, semi-automatic selective imaging, and automatic selective imaging. Manual Selective Imaging is where a forensic investigator chooses exactly which files are captured. For example, the investigator can use an interface similar to that of a file browser and is able to navigate the directory tree and choose which files to acquire.

Semi-automatic selective imaging is where a forensic investigator decides which file types or categories of information to capture. This may be based on file extension, file signature, or file hash, or some other definable criteria. When using a selective approach based on file hashes it is important to record which files are present and their provenance, even though the contents of each file may not be captured. It is also be prudent to record referential hash set information.

Automatic selective imaging is where an investigator selects the source and destination devices and the imager automatically acquires the evidence. This is accomplished in a selective manner according to pre-configured parameters or the particular circumstances pertaining to the case/investigation.

The different operating modes that a selective approach presents to the investigator, combined with the flexibility and many options for classifying and grouping information, potentially makes the task very complex. One of the difficulties with selective imaging is recording the provenance of each item selected. This provides a number of options and there is often more than one metric that can be used to record the provenance of an item of information. For example, the location of a particular file on a disk could be recorded in any or all of the following ways:
physical sector locations (data runs);
logical cluster locations within a volume, with the addition of an offset from the beginning of the physical device;
folder location specified from the root folder. This must include partition reference information.

It is not in general possible to categorise any one of these forms as inherently better than any other; none signifies that the evidence associated with it is in ay way inherently ‘better’ or has more integrity than that associated with any other method.

Provenance indications are preferably unique, unambiguous, concise, and repeatable. Each method meets these criteria in different ways, dependent upon the technical knowledge of the person trying to understand it. For example the general public, a judge, or a legal professional is likely to be more familiar with the concept of a folder location than a more technical concept such as absolute location or cluster reference. These other ‘more technical’ provenance descriptions may only complicate matters by introducing more technical vocabulary which in practice detracts from and obscures the real information that is to be presented. In an ideal world all relevant provenential descriptions would be captured though in practice this may not be practical. Nevertheless it is considered desirable to be able to capture multiple indications of provenance associated with any given evidence, rather than be restricted to capturing only one in each case.

This would lead to multiple provenential definitions, for example:
Primary Provenential Key=Physical sector locations;
Secondary Provenential Key=Logical cluster locations within a volume with the addition of an offset from the beginning of the physical device;
Tertiary Provenential Key=Folder location specified from the root folder.

It is also possible to have a DEB containing one or more other DEBs: that is, the content type of a DEB may also itself be a DEB. This ability to encapsulate DEBs within DEBs permits a parallel approach to be taken to the acquisition process, thus combining the acquired evidence into one entity for analysis. One example of this would be the simultaneous acquisition of data from distinct disks making up a RAID set: each disk may be captured, potentially concurrently, in a separate DEB and these DEBs in turn encapsulated in a further DEB. Other examples in which data may be concurrently or hierarchically gathered into DEBs will be apparent to the skilled person.

DEBs also support the duplication of either all or selected information from a given source DEB whereby to create another DEB, together with an audit trail showing the provenance of the copied information. The audit trail may be shown both in the tag field of the originating DEB from which the new DEB is created and in the tag field of the new DEB itself. The original DEB will contain an indication that an application has extracted certain information, whilst the new DEB will contain an indication of where the information contained in it came from.

DEBs may of course be stored on or transmitted via any form of digital medium including, but not limited to, optical, magnetic and wireless media.

Any range or device value given herein may be extended or altered without losing the effect sought, as will be apparent to the skilled person for an understanding of the teachings herein.

1. A method of capturing digital data, the method comprising the steps of:
copying digital data from a data source into one or more evidence files;
for each evidence file recording data descriptive of at least one of the source and the contents of the digital data in the evidence file;
recording, in a tag file, data indicative of provenance of the digital data in the one or more evidence files.

2. A method according to claim 1 in which digital data is copied into a plurality of evidence files.

3. A method according to claim 1 in which the digital data is selectively copied from the data source into the one or more evidence files.

4. A method according to claim 1 in which, for each evidence file, the data descriptive of one of the source and contents of the digital data is stored in an index file distinct from the evidence file.

5. A method according to claim 4 in which a distinct index file is created for each evidence file.

6. A method according to claim 1 in which at least the data descriptive of one of the source and contents of the digital data comprises a digital fingerprint of the digital data.

7. A method according to claim 1 in which the tag file comprises a digital fingerprint of at least one of the evidence files.

8. A method according to claim 1 in which the tag file comprises a description of the format of the data descriptive of one of the source and contents of the digital data.

9. A method according to claim 1 in which the data source is a data storage medium.

10. A method according to claim 1 in which the data source is a data transmission medium.

11. A method according to claim 1 in which multiple indications of provenance are associated with at least one given item of the digital data in the one or more evidence files.

12. A program for a computer having respective code portions and data structures to perform the steps of the method of claim 1.

13. Apparatus for capturing digital data, the apparatus comprising:
means for copying digital data from a data source into one or more evidence files;
for each evidence file, means for recording data descriptive of at least one of the source and the contents of the digital data in the evidence file;
means arranged to record, in a tag file, data indicative of provenance of the digital data in the one or more evidence files.

14. A data structure for capturing digital data, the data structure comprising:
at least one evidence file for containing digital data copied from a data source;
at least one index file containing data descriptive of at least one of the source and contents of the digital data in the at least one evidence files;
a tag file containing data indicative of provenance of the digital data in the at least one evidence files.

15. A method of accessing a data structure according to claim 13, the method comprising the steps of:
identifying one or more evidence files to be accessed;
recording details of the evidence file access in the tag file of the data structure;
recording a new integrity check value in the tag file, responsive to the contents of the tag file including the newly-recorded details of the evidence file access.

16. A method according to claim 15 in which the details of the evidence file access comprise at least one of:
identification of the application performing the evidence file access;
identification of the user requesting evidence file access;
identification of the time of evidence file access;

17. A method according to claim 16 in which the integrity check is a digital fingerprint.

18. A method according to claim 17 in which the digital fingerprint is one of a CRC digits, an MD5 hash, and a SHA hash.

19. Apparatus for accessing a data structure according to claim 14, the apparatus comprising:
means for identifying one or more evidence files to be accessed;
means for recording details of the evidence file access in the tag file of the data structure;
means for recording a new integrity check value in the tag file, responsive to the contents of the tag file including the newly-recorded details of the evidence file access.

20. A method of updating a data structure according to claim 14, the method comprising the steps of:
accessing the data structure to extract evidential data contained within it;
processing evidential data extracted from the data structure to create a new evidence file and corresponding index file;
adding the new evidence file and index file to the existing data structure;
appending continuity information to the tag file of the data structure indicative of the addition of the new evidence file and index file.

21. Apparatus for updating a data structure according to claim 14, the apparatus comprising:
means for accessing the data structure to extract evidential data contained within it;
means for processing evidential data extracted from the data structure to create a new evidence file and corresponding index file;
means for adding the new evidence file and index file to the existing data structure;
means for appending continuity information to the tag file of the data structure indicative of the addition of the new evidence file and index file.

22. (canceled)
